(19) United States
(12) Patent Application Publication
(10) Pub. No.: US 2026/0105233 A1
(43) Pub. Date: Apr. 16, 2026

(54) MOPSO-INCORPORATED INTELLIGENT OPTIMIZATION METHOD FOR RELIABILITY OF COMPUTE-IN-MEMORY CHIPLET-BASED 2.5D PACKAGING

(71) Applicants: Nanjing University of Posts and Telecommunications, Nanjing (CN); Nantong Institute Of Nanjing University Of Posts And Telecommunications Co., Ltd., Nantong (CN)

(72) Inventors: Jie Wu, Nanjing (CN); Guangyao Chen, Nanjing (CN); Ruiyang Pang, Nanjing (CN); Xuqi Yang, Nanjing (CN); Zhikuang Cai, Nanjing (CN); Lei Wang, Nanjing (CN)

(21) Appl. No.: 19/209,842

(22) Filed: May 16, 2025

(30) Foreign Application Priority Data
Oct. 14, 2024 (CN) 202411426351.9

(51) Int. Cl. G06F 30/337; G06F 111/06

(52) U.S. Cl. CPC G06F 30/337; G06F 2111/06

(57) ABSTRACT

This invention presents an intelligent reliability optimization method for Compute-in-Memory chiplet 2.5D packaging using MOPSO. The approach integrates Taguchi orthogonal experiments to establish a finite element model of critical bump parameters, coupled with signal-to-noise ratio range analysis and weighted percentage evaluation for multi-objective prioritization. Stress and warpage relationships are mathematically modeled via least squares fitting and optimized through a multi-objective particle swarm algorithm. The optimized packaging achieves a 21.2% reduction in thermal stress and 61.7% lower warpage deformation compared to conventional designs. With balanced thermo-mechanical reliability and performance metrics, this method surpasses existing packaging solutions in proactive risk mitigation, supporting heterogeneous integration for next-generation 3D-IC architectures. The framework enables predictive optimization of structural parameters prior to fabrication, addressing reliability challenges in advanced chiplet-based systems.

### TECHNICAL FIELD

The present invention belongs to the field of advanced packaging technology in integrated circuit, and more specifically, relates to a MOPSO-incorporated intelligent optimization method for reliability of Compute-in-Memory chiplet-based 2.5D Packaging.

### BACKGROUND

Electronic devices are subjected to multiple repeated thermal loadings during fabrication and service, and Coefficient of thermal expansion (CTE) of joint structures introduced the generation of internal stresses. Although these stresses are much smaller than the fracture strength of the joint, stress can cause damage at critical locations with the repeated external thermal cycling loads. In large-scale wafer packaging, unreasonable material combination or structural design led to structural warping, directly affecting the coplanarity of body packaging, causing chip fracture, delamination and other issues, thereby affecting product performance and service life.

Considering the complex nonlinear relationships, multi-objective constraints, and traditional methods that are difficult to efficiently handle in packaging structure optimization, machine learning combined with MOPSO algorithm for optimization can be applied. When the two are combined, machine learning provides initial solutions or guides the search direction for MOPSO algorithm, which verifies and corrects the prediction results of machine learning model, and the synergistic effect significantly improves optimization efficiency and accuracy, ensuring that the final optimization results can effectively reduce the packaging warpage and stress, and improving packaging reliability and product life.

### SUMMARY

The purpose of invention is to Co-optimize the material and structural parameters for Compute-in-Memory chiplet-based 2.5D packaging through machine learning and MOPSO algorithm, and finally to reduce the reliability failure caused by warpage and excessive stress in advance.

In order to solve the technical issues mentioned above, according to one aspect of the present invention, there is provided an intelligent optimization method for the reliability of Compute-in-Memory chiplet-based 2.5D Packaging, comprising the following steps: S1. Determine the key bump parameters of Compute-in-Memory chiplet-based 2.5D packaging structure: The key bump parameters include the diameter and height of C2 bump on the lower surface of the integrated chip, the height and radius of C4 bump connected to the silicon transfer board, and the material of C4 bump. They are divided into different horizontal combinations according to Taguchi orthogonal method, and an orthogonal experimental table is designed:

S2. An equivalent finite element model of a Compute-in-Memory chiplet-based 2.5D Packaging was established based on the horizontal combination divided by Taguchi orthogonal experiment. The thermal cycle temperature curve was set for the equivalent finite element model, simulating the quality indicators, and recording them in the orthogonal experiment table:

S3. For multi-objective quality indicators, the percentage weighted evaluation method and the range analysis method of signal-to-noise ratio are used to determine the C2 bump diameter and height, and the comprehensive influence degree ranking of C4 bump height, radius and materials:

S4. Using the range analysis method of signal-to-noise ratio to achieve multi-objective comprehensive evaluation, weighting is carried out on a percentage basis based on the calculated weight proportion to obtain comprehensive scores for different level combinations. The orthogonal experimental design results are analyzed to determine the optimal structure parameter scheme of Compute-in-Memory chiplet-based 2.5D Packaging:

S5. Based on the orthogonal experimental results in steps S2 and S4, the least squares method to fit the functions of stress, warping, and comprehensive scoring was used:

S6. Multiple target variables was optimized with MOPSO model, on which the finite element model was modified. The optimized quality indicators was simulated, which was compared with the corresponding structural parameter simulation results for verification:

Furthermore, in S1, the diameter and height of C2 bumps on the lower surface of the integrated chip, as well as the height, radius, and material of C4 bumps connected to the silicon transfer board, are divided into different horizontal combinations: Taguchi orthogonal experimental table was designed to select factors and their respective level values to input into the software for experimental design:

Furthermore, in S2, the quality indicators are set as the maximum warpage value, average stress value, maximum warpage value of the silicon transfer board, and maximum stress value of the C4 bump connected to the substrate of Application Specific Integrated Circuit (ASIC) integrated chip: A finite element model of a 2.5D packaged product based on the combination parameters listed in the Taguchi method is established, and then the finite element software was used to simulate to obtain quality indicators:

Furthermore, in S3, the range analysis method based on signal-to-noise ratio is used to determine the impact ranking of C2 bump diameter, C2 bump height, C4 bump height, C4 bump radius, and C4 bump material on different quality indicators;

The range analysis method of signal-to-noise ratio was used to obtain the influence weights of each factor on quality indicators, and the weight proportion was established.

Furthermore, in S4, the comprehensive evaluation of the impact of each factor on quality indicators is obtained using the methods of percentage weighted evaluation and range analysis according to the weight proportion. The smaller the score, the better the parameter combination. The results of the orthogonal experimental design are analyzed, and the optimal parameter scheme is determined based on the ranking of comprehensive impact degree and the value of the signal-to-noise ratio. The percentage weighted evaluation formula is:

$${S}_{i} = {\sum }_{k = 1}^{6} {w}_{k} \times {Y}_{ki}$$

Among them, i represents the experiment number, k represents the quality index number, Si represents the comprehensive score of the i-th group of experiments, wₖ represents the weight proportion, and Y_{Ki} represents the quality index data result.

Furthermore, in S5, based on the orthogonal experimental table, the C2 bump diameter, C2 bump height, C4 bump height, C4 bump radius, and C4 bump material were used as design variables to fit the quality indicators of the maximum warpage value of ASIC integrated chip, the average stress value of silicon transfer board, and comprehensive score function with the least squares method.

Furthermore, in S6, based on the fitted function, the MOPSO model is used to optimize multiple target variables within the horizontal division range determined in step S1. The optimization results are compared with the corresponding structural parameter simulation results for verification.

According to another aspect of the present invention, there is provided a computer-readable storage medium storing a computer program, which, when executed by a processor, implements the steps of nonlinear geometric phase liquid crystal element, preparation method, and application of present invention.

According to another aspect of the present invention, there is provided a computer device comprising a memory, a processor, and a computer program stored on the memory and executable on the processor. The execution of the program by the processor is a step in implementing the nonlinear geometric phase liquid crystal element, preparation method, and application of the present invention.

Compared with existing technologies, the beneficial effects of the above method of present invention are as follows: in the present invention, the weights of bump structure and material parameters on a single quality index are determined through Taguchi orthogonal experiment and range analysis of signal-to-noise ratio, respectively. Then, the optimal combination of bump structure and material parameters is determined through a comprehensive score weighted by a percentage system. The structural and material parameters of bumps are used as design variables, and the function is fitted by least squares method. Finally, the MOPSO model is used to optimize the variables, and the optimal structural and material parameters of the bump are obtained, which is compared to those obtained through a comprehensive score weighted by a percentage system. Finally, the optimal combination of structure and material parameters of Compute-in-Memory chiplet-based 2.5D packaging is obtained. This invention can improve the efficiency and accuracy of the optimal structure and material parameters combination of the 2.5D packaging, finally reducing the packaging warpage and stress, and avoiding reliability failure risk in advance.

### BRIEF DESCRIPTION OF DRAWINGS

In order to more clearly illustrate technical solutions of embodiments of the invention or the prior art, drawings will be used in the description of embodiments or the prior art will be given a brief description below. Apparently, the accompanying drawings described below only relate to some embodiments of the present invention and are not intended to limit the invention.

FIG. 1 is a flowchart of embodiment 1 of the present invention;

FIG. 2 is a structural diagram of the finite element model of embodiment 1 of the present invention:

FIG. 3 is a flowchart of the MOPSO algorithm in embodiment 1 of the present invention:

FIGS. 4A-4D illustrate the spatial distribution of the Pareto solution in embodiment 1 of the present invention:

FIG. 5 is a comparison of warpage simulation before and after optimization in embodiment 1 of the present invention:

FIG. 6 is the comparison of the results before and after optimization in embodiment 1 of the present invention.

### DETAILED DESCRIPTION OF THE PREFERRED EMBODIMENTS

In order to clarify the purpose, technical solution, and advantages of the embodiments of the present invention, the following will provide a clear and complete description of the technical solution of the embodiments of the present invention in conjunction with the accompanying drawings. Obviously, the described embodiments are a part of the embodiments of the present invention, not all embodiments. Based on the described embodiments of the invention, all other embodiments obtained by ordinary skill in the art without creative effort belong to the scope of protection of the invention.

Unless otherwise defined, the technical or scientific terms used herein shall have the usual meanings as understood by those skilled in the art to which the present invention belongs.

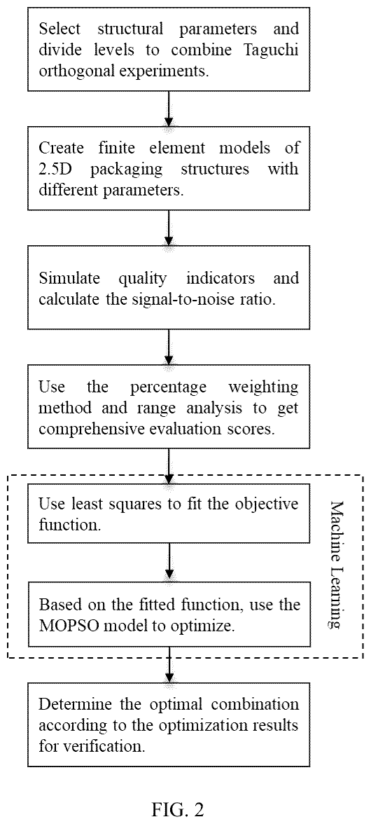

Embodiment 1: As shown in FIG. 2, the Compute-in-Memory chiplet-based 2.5D Packaging structure applied in this embodiment includes: substrate 1, reinforcement ribs 2, C4 bumps 3 connecting the silicon interposer to the substrate, silicon interposer 4, C2 bumps 5 connecting the ASIC chip to the silicon interposer, ASIC chip 6, C4 bumps 7 on the lower surface of HBM chip, DRAM stacked chips 8 in the HBM, and C2 bumps 9 connecting DRAM.

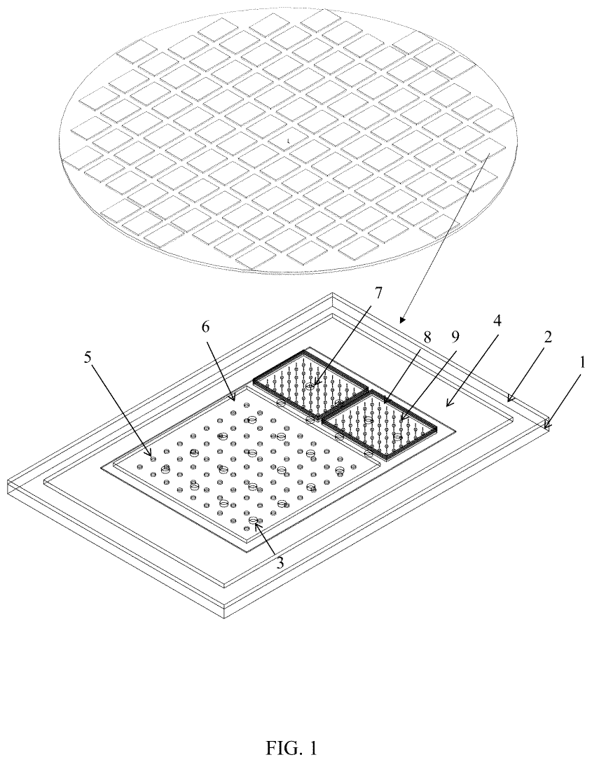

This embodiment provides a machine learning (i.e. MOPSO) based intelligent optimization method for the reliability of Compute-in-Memory chiplet-based 2.5D packaging, as shown in FIG. 1, including the following steps:

S1. Select the key structural parameters of the Compute-in-Memory chiplet-based 2.5D packaging, including the diameter and height of C2 bumps on the lower surface of the integrated chip, the height, radius and material of C4 bumps connected to the silicon interposer and substrate. Based on the actual sample data produced by the enterprise, various structural parameters is divided into different horizontal combinations. Taguchi orthogonal table was designed, where the structural parameters and their respective horizontal values were input.

Table 1 shows the selection of structural parameters based on the actual sample data produced by the enterprise. Table 2 presents 27 combinations of different bump parameters.

TABLE 1
Structural Parameters and Levels

| | | | | | | C4 |
|---|---|---|---|---|---|---|
| | | C2 Bump | C2 Bump | C4 Bump | C4 Bump | Bump |
| Parameter | | Diameter | Height B | Height C | Radius D | Material |
| Description | | A (mm) | (mm) | (mm) | (mm) | E |
| Level | 1 | 0.3 | 0.1 | 0.3 | 0.42 | SAC305 |
| | 2 | 0.4 | 0.12 | 0.33 | 0.45 | Nano- |
| | | | | | | silver |
| | 3 | 0.5 | 0.15 | 0.36 | 0.47 | SAC387 |

TABLE 2
Combination of different bump parameters and material types

| ID | A | B | C | D | E |
|---|---|---|---|---|---|
| 1 | 1 | 1 | 1 | 1 | 1 |
| 2 | 1 | 1 | 1 | 1 | 2 |
| 3 | 1 | 1 | 1 | 1 | 3 |
| 4 | 1 | 2 | 2 | 2 | 1 |
| 5 | 1 | 2 | 2 | 2 | 2 |
| 6 | 1 | 2 | 2 | 2 | 3 |
| 7 | 1 | 3 | 3 | 3 | 1 |
| 8 | 1 | 3 | 3 | 3 | 2 |
| 9 | 1 | 3 | 3 | 3 | 3 |
| 10 | 2 | 1 | 2 | 3 | 1 |
| 11 | 2 | 1 | 2 | 3 | 2 |
| 12 | 2 | 1 | 2 | 3 | 3 |
| 13 | 2 | 2 | 3 | 1 | 1 |
| 14 | 2 | 2 | 3 | 1 | 2 |
| 15 | 2 | 2 | 3 | 1 | 3 |
| 16 | 2 | 3 | 1 | 2 | 1 |
| 17 | 2 | 3 | 1 | 2 | 2 |
| 18 | 2 | 3 | 1 | 2 | 3 |
| 19 | 3 | 1 | 3 | 2 | 1 |
| 20 | 3 | 1 | 3 | 2 | 2 |
| 21 | 3 | 1 | 3 | 2 | 3 |
| 22 | 3 | 2 | 1 | 3 | 1 |
| 23 | 3 | 2 | 1 | 3 | 2 |
| 24 | 3 | 2 | 1 | 3 | 3 |
| 25 | 3 | 3 | 2 | 1 | 1 |
| 26 | 3 | 3 | 2 | 1 | 2 |
| 27 | 3 | 3 | 2 | 1 | 3 |

S2. A finite element model of a Compute-in-Memory chiplet-based 2.5D packaging structure with different structural parameters was established and then a thermal cycling is applied on the model. The temperature curve is set according to the GJB 150.5A-2009 temperature cycle experiment loading standard. A single temperature cycle experiences: from 0 s to 600 s, the temperature rises from room temperature 20° C. to 125° C., with a heating rate of 0.2° C./s, and the high temperature is maintained for 15 minutes (600 s-1500 s); From 1500 s to 2400 s, the temperature drops from high temperature 125° C. to −55° C., with a cooling rate of 0.2° C./s, and the low temperature is maintained for 15 minutes (2400 s-3300 s). The next temperature cycle starts from −55° C., and the heating, insulation, and cooling time stages are all 900 s. This simulation loads three temperature cycles in total. The quality indicators was simulated, which included the maximum warpage value and the average stress value of ASIC, the maximum warpage value of DRAM chip, the maximum warpage value and the average stress value of silicon interposer, and the maximum stress value of C4 bump.

Table 3 shows the orthogonal design table. Due to the large amount of data used as quality indicators, their different dimensions and data normalization is required to obtain the comprehensive score for each group.

TABLE 3
Orthogonal Design Table

| | | | Maximum | | | |
|---|---|---|---|---|---|---|
| | Maximum | Averaged | Warpage of | Maximum | Averaged | Maximum |
| | Warpage of | Stress of | DRAM | Warpage of | Stress of | Stress of C4 |
| | ASIC Y1 | ASIC Y2 | Chip Y3 | Interposer | Interposer | Bumps Y6 |
| ID | (μm) | (MPa) | (μm) | Y4 (μm) | Y5 (MPa) | (MPa) |
| 1 | 0.14722 | 4.5881 | 0.061427 | 0.27483 | 10.226 | 23.719 |
| 2 | 0.10996 | 6.3882 | 0.29513 | 0.30942 | 13.587 | 17.951 |
| 3 | 0.07569 | 14.059 | 0.058437 | 0.075681 | 26.626 | 59.042 |
| 4 | 0.12522 | 10.899 | 0.074335 | 0.29916 | 11.099 | 24.472 |
| 5 | 0.11112 | 12.298 | 0.30769 | 0.31478 | 14.659 | 18.462 |
| 6 | 0.06564 | 18.746 | 0.066347 | 0.06698 | 27.982 | 59.725 |
| 7 | 0.16596 | 4.2471 | 0.010036 | 0.43912 | 14.371 | 24.177 |
| 8 | 0.08297 | 4.9763 | 0.099379 | 0.19607 | 16.835 | 16.68 |
| 9 | 0.01322 | 9.1629 | 0.067905 | 0.12886 | 31.173 | 57.676 |
| 10 | 0.12835 | 11.535 | 0.093826 | 0.34636 | 11.706 | 25.588 |
| 11 | 0.10229 | 13.091 | 0.2902 | 0.29953 | 15.608 | 17.985 |
| 12 | 0.05933 | 19.588 | 0.064059 | 0.064953 | 29.267 | 58.812 |
| 13 | 0.12281 | 12.148 | 0.052762 | 0.2548 | 9.0321 | 23.738 |
| 14 | 0.08842 | 12.783 | 0.28764 | 0.28965 | 10.988 | 16.792 |
| 15 | 0.04461 | 18.042 | 0.022482 | 0.04458 | 22.991 | 57.727 |
| 16 | 0.17946 | 4.1786 | 0.11368 | 0.40695 | 14.245 | 24.567 |
| 17 | 0.09325 | 5.5554 | 0.22444 | 0.25245 | 18.552 | 18.284 |
| 18 | 0.0605 | 10.127 | 0.051313 | 0.06096 | 32.858 | 59.708 |
| 19 | 0.12084 | 11.586 | 0.04833 | 0.28127 | 9.9466 | 23.685 |
| 20 | 0.09229 | 12.359 | 0.2919 | 0.28815 | 12.296 | 16.614 |
| 21 | 0.06341 | 18.099 | 0.06471 | 0.068963 | 24.983 | 55.496 |
| 22 | 0.15907 | 14.209 | 0.092191 | 0.29728 | 11.498 | 24.644 |
| 23 | 0.10109 | 15.335 | 0.35049 | 0.3105 | 14.94 | 20.782 |
| 24 | 0.06245 | 21.527 | 0.068996 | 0.071645 | 28.799 | 72.675 |
| 25 | 0.14925 | 3.8894 | 0.12548 | 0.37183 | 12.097 | 23.926 |
| 26 | 0.10446 | 5.099 | 0.24486 | 0.27233 | 15.95 | 17.64 |
| 27 | 0.06637 | 10.067 | 0.050486 | 0.066549 | 30.022 | 59.143 |

S3. The signal-to-noise ratio of each quality indicator is calculated, and compiling it into the experimental table shown in Table 4. The signal-to-noise ratio can truly reflect the impact of different structural parameter combinations on quality indicator data, which can be analyzed based on three characteristics: Larger-the-better, Smaller-the-better, Nominal-the-best. Signal-to-noise ratio calculation formulas for different characteristics are different.

The warpage and stress values are both desirable “Smaller-the-better” characteristics, and the signal-to-noise ratio calculation formulas for different characteristics are different:

Smaller-the-better type characteristics:

$$\frac{S}{N} = - 10 lg ( \frac{1}{n} {\sum }_{i = 1}^{n} {y}_{i}^{2} )$$

In the above context, S/N represents the signal-to-noise ratio, n denotes the number of sample data points, and yᵢ is the actual calculated value of the i-th experimental result.

Larger-the-better type characteristics:

$$\frac{S}{N} = - 10 lg ( \frac{1}{n} {\sum }_{i = 1}^{n} {y}_{i}^{- 2} )$$

In the above context, S/N represents the signal-to-noise ratio, n denotes the number of sample data points, and yᵢ is the actual calculated value of the i-th experimental result.

Nominal-the-better type characteristics:

$${V}_{e} = \frac{1}{n - 1} {\sum }_{i = 1}^{n} {( {y}_{i} - \overline{y} )}^{2} , \frac{S}{N} = \frac{n {\overline{y}}^{2} - {V}_{e}}{{nV}_{e}}$$

In the above context, S/N represents the signal-to-noise ratio, Vₑ denotes the sample variance, n is the number of sample data points, y̅ is the mean value, and yᵢ is the actual calculated value of the i-th experimental result.

The range analysis method of signal-to-noise ratio is used to obtain the ranking of the influence degree of each bump parameter on the comprehensive quality index, and then the weight R value of the influence of each bump parameter and material type on the quality index is determined. The larger the R value, the greater the influence degree. Table 5 shows the signal-to-noise ratio response table.

TABLE 4
Signal to Noise Ratio Experiment Table

| | | | | S/N Ratio | | |
|---|---|---|---|---|---|---|
| | | | S/N Ratio | of | S/N Ratio | S/N Ratio |
| | S/N Ratio | S/N Ratio | of | Maximum | of | of |
| | of | of | Maximum | Warpage | Averaged | Maximum |
| | Maximum | Averaged | Warpage | of | Stress of | Stress of |
| | Warpage | Stress of | of DRAM | Interposer | Interposer | C4 Bumps |
| ID | of ASIC 1 | ASIC 2 | Chip 3 | 4 | 5 | 6 |
| 1 | 16.641 | −13.233 | 24.233 | 11.219 | −20.194 | −27.502 |
| 2 | 19.175 | −16.108 | 10.600 | 10.189 | −22.662 | −25.082 |
| 3 | 22.419 | −22.959 | 24.666 | 22.420 | −28.506 | −35.423 |
| 4 | 18.047 | −20.748 | 22.576 | 10.482 | −20.906 | −27.773 |
| 5 | 19.084 | −21.797 | 10.238 | 10.040 | −23.322 | −25.326 |
| 6 | 23.656 | −25.458 | 23.564 | 23.481 | −28.938 | −35.523 |
| 7 | 15.600 | −12.562 | 39.969 | 7.148 | −23.150 | −27.668 |
| 8 | 21.621 | −13.938 | 20.054 | 14.152 | −24.524 | −24.444 |
| 9 | 37.577 | −19.241 | 23.362 | 17.798 | −29.876 | −35.220 |
| 10 | 17.832 | −21.240 | 20.554 | 9.209 | −21.368 | −28.161 |
| 11 | 19.803 | −22.339 | 10.746 | 10.471 | −23.867 | −25.098 |
| 12 | 24.534 | −25.840 | 23.868 | 23.748 | −29.328 | −35.389 |
| 13 | 18.215 | −21.690 | 25.554 | 11.876 | −19.116 | −27.509 |
| 14 | 21.069 | −22.133 | 10.823 | 10.763 | −20.818 | −24.502 |
| 15 | 27.012 | −25.126 | 32.963 | 27.017 | −27.231 | −35.228 |
| 16 | 14.921 | −12.421 | 18.886 | 7.809 | −23.073 | −27.807 |
| 17 | 20.607 | −14.894 | 12.978 | 11.956 | −25.368 | −25.241 |
| 18 | 24.364 | −20.110 | 25.795 | 24.299 | −30.333 | −35.521 |
| 19 | 18.356 | −21.279 | 26.316 | 11.018 | −19.953 | −27.489 |
| 20 | 20.697 | −21.840 | 10.695 | 10.808 | −21.795 | −24.409 |
| 21 | 23.956 | −25.153 | 23.781 | 16.4384 | −27.953 | −34.885 |
| 22 | 15.968 | −23.051 | 20.706 | 13.6626 | −21.212 | −27.834 |
| 23 | 19.906 | −23.714 | 9.106 | 13.928 | −23.487 | −26.354 |
| 24 | 24.089 | −26.660 | 23.224 | 16.341 | −29.188 | −37.228 |
| 25 | 16.522 | −11.798 | 18.029 | 13.6518 | −21.654 | −27.577 |
| 26 | 19.621 | −14.150 | 12.222 | 13.9172 | −24.055 | −24.930 |
| 27 | 23.561 | −20.058 | 25.937 | 14.3772 | −29.549 | −35.438 |

TABLE 5
Signal to Noise Ratio Response Table

| Level | A | B | C | D | E |
|---|---|---|---|---|---|
| 1 | −23.31 | −23.32 | −23.78 | −23.09 | −21.32 |
| 2 | −23.58 | −23.84 | −23.6 | −23.51 | −20.35 |
| 3 | −23.66 | −23.39 | −23.18 | −23.96 | −28.89 |
| R | 0.35 | 0.52 | 0.6 | 0.87 | 8.54 |
| Rank | 5 | 4 | 3 | 2 | 1 |

S4. By using the range analysis method of signal-to-noise ratio to achieve multi-objective comprehensive evaluation, the weights of each quality indicator are calculated, all signal-to-noise ratios are added to obtain their dimensionless mean, and then the weights of each quality indicator are added up. Based on the weights of each quality indicator, the comprehensive score of each structural combination is calculated, as shown in Table 6.

The percentage weighted evaluation formula is:

$${S}_{i} = {\sum }_{k = 1}^{6} {w}_{k} \times {Y}_{ki}$$

Table 7 is the experimental table after statistical comprehensive scoring.

TABLE 6
Weight of Quality Indicators

| Performance Indicator | Normalized Mean | Weight |
|---|---|---|
| Maximum Warpage of ASIC | 20.921 | 0.161 |
| Averaged Stress of ASIC | 19.983 | 0.154 |
| Maximum Warpage of DRAM Chip | 20.424 | 0.157 |
| Maximum Warpage of Interposer | 14.672 | 0.113 |
| Averaged Stress of Interposer | 24.497 | 0.189 |
| Maximum Stress of C4 Bumps | 29.428 | 0.227 |
| Total | 129.925 | 1 |

TABLE 7
S/N Ratio Experiment Table

| | | | Maximum | Maximum | | | |
|---|---|---|---|---|---|---|---|
| | Maximum | Average | Warpage | Warpage | Average | Maximum | |
| | Warpage | Stress of | of DRAM | of | Stress of | Stress of | |
| | of ASIC | ASIC Y2 | Chip Y3 | Interposer | Interposer | C4 Bumps | Comprehensive |
| ID | Y1 (μm) | (MPa) | (μm) | Y4 (μm) | Y5 (MPa) | Y6 (MPa) | Score Y7 |
| 1 | 0.14722 | 4.5881 | 0.061427 | 0.27483 | 10.226 | 23.719 | 8.078 |
| 2 | 0.10996 | 6.3882 | 0.29513 | 0.30942 | 13.587 | 17.951 | 7.712 |
| 3 | 0.07569 | 14.059 | 0.058437 | 0.075681 | 26.626 | 59.042 | 20.603 |
| 4 | 0.12522 | 10.899 | 0.074335 | 0.29916 | 11.099 | 24.472 | 9.386 |
| 5 | 0.11112 | 12.298 | 0.30769 | 0.31478 | 14.659 | 18.462 | 8.942 |
| 6 | 0.06564 | 18.746 | 0.066347 | 0.06698 | 27.982 | 59.725 | 21.734 |
| 7 | 0.16596 | 4.2471 | 0.010036 | 0.43912 | 14.371 | 24.177 | 8.922 |
| 8 | 0.08297 | 4.9763 | 0.099379 | 0.19607 | 16.835 | 16.68 | 7.769 |
| 9 | 0.01322 | 9.1629 | 0.067905 | 0.12886 | 31.173 | 57.676 | 20.391 |
| 10 | 0.12835 | 11.535 | 0.093826 | 0.34636 | 11.706 | 25.588 | 9.860 |
| 11 | 0.10229 | 13.091 | 0.2902 | 0.29953 | 15.608 | 17.985 | 9.129 |
| 12 | 0.05933 | 19.588 | 0.064059 | 0.064953 | 29.267 | 58.812 | 21.896 |
| 13 | 0.12281 | 12.148 | 0.052762 | 0.2548 | 9.0321 | 23.738 | 9.014 |
| 14 | 0.08842 | 12.783 | 0.28764 | 0.28965 | 10.988 | 16.792 | 7.938 |
| 15 | 0.04461 | 18.042 | 0.022482 | 0.04458 | 22.991 | 57.727 | 20.221 |
| 16 | 0.17946 | 4.1786 | 0.11368 | 0.40695 | 14.245 | 24.567 | 8.991 |
| 17 | 0.09325 | 5.5554 | 0.22444 | 0.25245 | 18.552 | 18.284 | 8.572 |
| 18 | 0.0605 | 10.127 | 0.051313 | 0.06096 | 32.858 | 59.708 | 21.315 |
| 19 | 0.12084 | 11.586 | 0.04833 | 0.28127 | 9.9466 | 23.685 | 9.089 |
| 20 | 0.09229 | 12.359 | 0.2919 | 0.28815 | 12.296 | 16.614 | 8.079 |
| 21 | 0.06341 | 18.099 | 0.06471 | 0.068963 | 24.983 | 55.496 | 20.110 |
| 22 | 0.15907 | 14.209 | 0.092191 | 0.29728 | 11.498 | 24.644 | 10.018 |
| 23 | 0.10109 | 15.335 | 0.35049 | 0.3105 | 14.94 | 20.782 | 9.994 |
| 24 | 0.06245 | 21.527 | 0.068996 | 0.071645 | 28.799 | 72.675 | 25.256 |
| 25 | 0.14925 | 3.8894 | 0.12548 | 0.37183 | 12.097 | 23.926 | 8.390 |
| 26 | 0.10446 | 5.099 | 0.24486 | 0.27233 | 15.95 | 17.64 | 7.874 |
| 27 | 0.06637 | 10.067 | 0.050486 | 0.066549 | 30.022 | 59.143 | 20.646 |

S5. The data in Table 3 is used as sample data, the quality index results are fitted using the least squares method. The maximum ASIC warpage value Y1 with high fitting degree, the average stress value Y5 of the silicon interposer, and the comprehensive score Y7 were selected to obtain the functional relationship between the quality index Y1, Y5, Y7 and the structural parameters A, B, C, D, E. The fitting results are as follows:

$${Y}_{1} = 0.3264 + 0.0 \; 123 A + 0.0 \; 431 B - 0.36 C - 0.0 \; 69 D - 0.0437 E$$

$${Y}_{5} = - 17.686 - 3.35 A + 7 5.18 B - 34.6 \; 58 C + 5 0.83 D + 8.36 E$$

$${Y}_{7} = - 6.76 + 3.29 A - 6.2 \; 66 B - 16.6 \; 765 C + 2 7.79 D + 6.1 \; 35 E$$

Perform variance analysis on the fitting functions Y1, Y5, and Y7, as shown in Tables 8-10. The results of the variance analysis for fitting functions Y1, Y5, and Y7 are 0.883146, 0.880799, and 0.850556, respectively, with determination coefficients greater than 0.85. This indicates that the parameters have a high explanatory power for the objective function, and the relationship between variables is significant. The P-values of the regression analysis for both fitting functions are less than 0.01, indicating of strong model significance, high fitting degree, and significant statistical significance.

TABLE 8
Y1 Function Analysis of Variance

| | df | SS | MS | F | P |
|---|---|---|---|---|---|
| Regression | 5 | 0.036602 | 0.00732 | 31.74229 | 4.15E−09 |
| Analysis | | | | | |
| Residual | 21 | 0.004843 | 0.000231 | | |
| Total | 26 | 0.041445 | | | |

TABLE 9
Y5 Function Analysis of Variance

| | df | SS | MS | F | P |
|---|---|---|---|---|---|
| Regression | 5 | 1373.385 | 274.677 | 31.03464 | 5.09E−09 |
| Analysis | | | | | |
| Residual | 21 | 185.8638 | 8.850657 | | |
| Total | 26 | 1559.249 | | | |

TABLE 10
Y7 Function Analysis of Variance

| | df | SS | MS | F | P |
|---|---|---|---|---|---|
| Regression | 5 | 693.1318 | 138.6264 | 10.11176 | 4.87E−05 |
| Analysis | | | | | |
| Residual | 21 | 287.8977 | 13.70942 | | |
| Total | 26 | 981.0295 | | | |

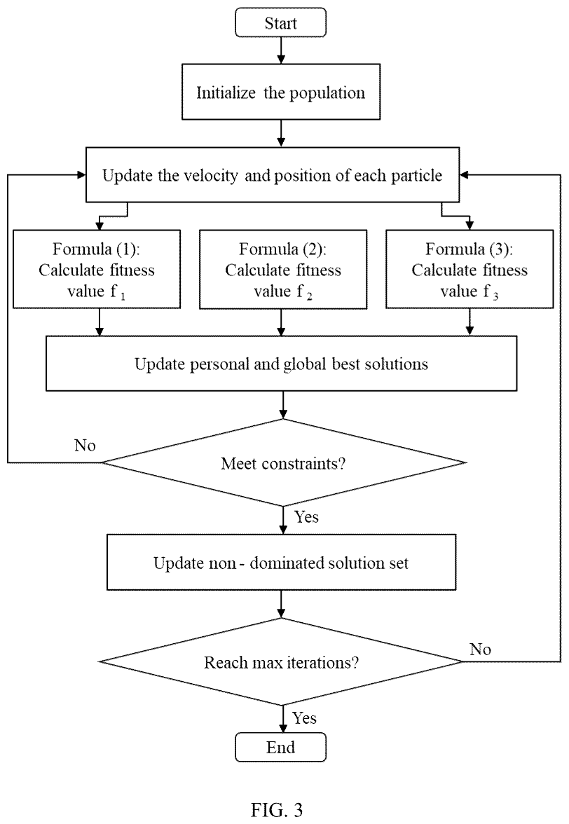

S6. Based on the fitted function, the MOPSO model is used to optimize the three target variables. The MOPSO flowchart is shown in FIG. 3, and the algorithm steps are as follows: (1) Population particle initialization, including initialization of particle velocity and position: (2) Particle fitness calculation and non dominated solution sets computation based on dominance relationships: (3) Solution of the external archive set updation and some low-quality solutions deletion: (4) Pbest particles updation based on Pareto dominance relationship: (5) A portion of particles from the external archive selection set as Gbest: (6) Properties of particles updation, namely position and velocity: (7) Iteration and termination.

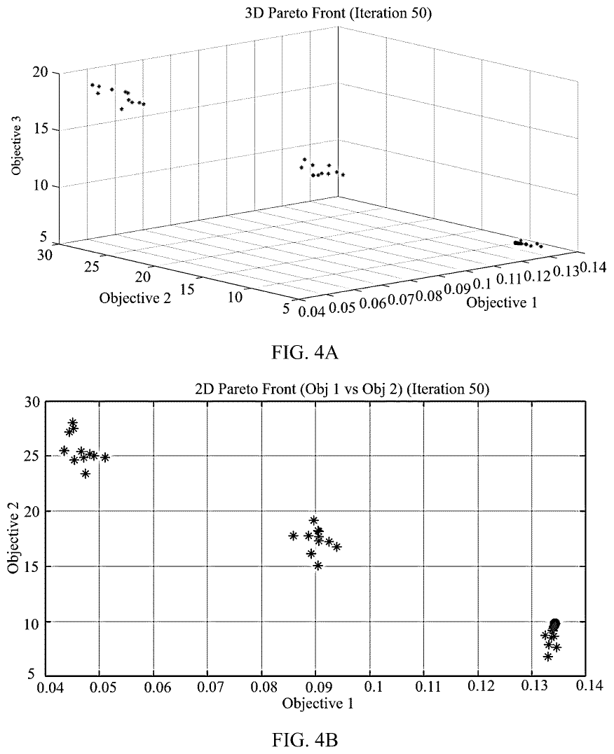

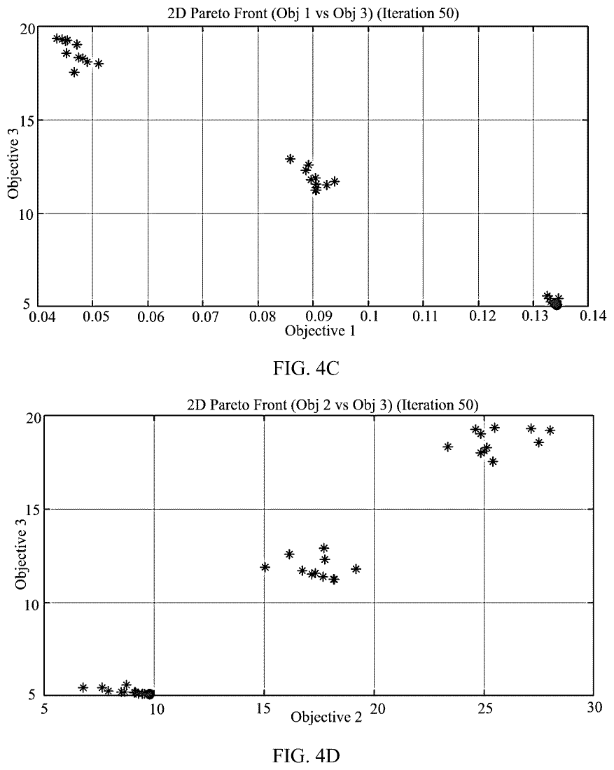

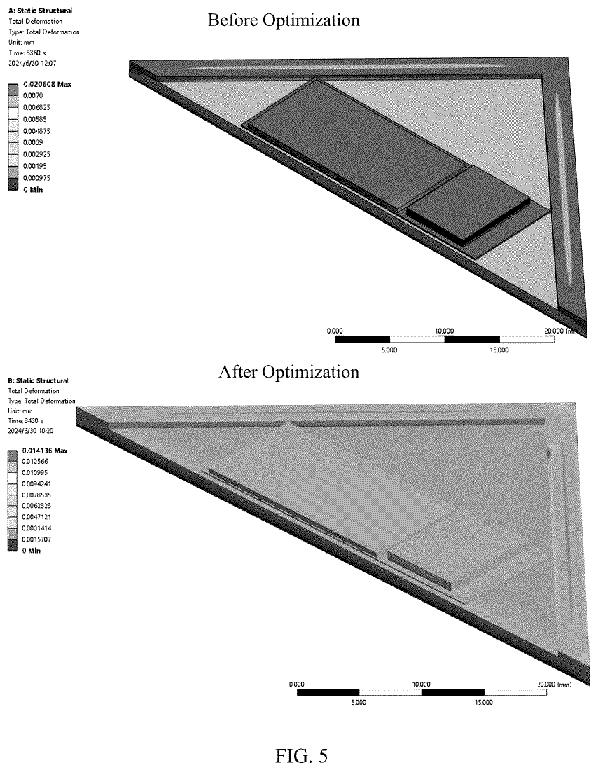

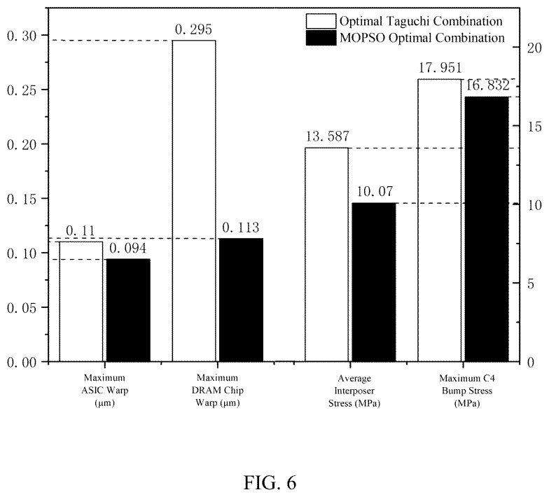

According to the MOPSO algorithm, the number of particles is set to 200, the number of iterations is 50, the optimization range is the horizontal division range determined in step S1, and the optimization objectives are Y1, Y5, and Y7, all of which are minimized. The optimization results of the algorithm are shown in FIGS. 4A-4D. The Pareto solution space is filtered and parameter A=0.3 mm, B=0.15 mm, C=0.36 mm, D=0.42 mm, E=1 is selected. According to the MOPSO algorithm, the optimal parameter combination was selected for re-modeling and finite element simulation. FIG. 5 shows the comparison of pre- and post-optimization warpage simulation. After optimization using MOPSO algorithm, the maximum warpage value of ASIC decreased by 14.6%, the maximum warpage value of DRAM chip decreased by 61.7%, the average stress value of silicon interposer decreased by 21.2%, and the maximum stress value of C4 bump decreased by 6.2%. FIG. 6 shows the comparison of pre- and post-optimization results. It can be seen that the present invention can efficiently select the optimal parameter combination among numerous different bump parameters and material types, to reduce the warpage and stress in Compute-in-Memory chiplet-based 2.5D Packaging under thermal service environment, and to avoid the corresponding reliability risk in advance.

Embodiment 2: The computer-readable storage medium of this embodiment stores a computer program, which, when executed by a processor, implements the steps of MOPSO-based reliability intelligent optimization method in Compute-in-Memory chiplet-based 2.5D Packaging in Embodiment 1.

The computer-readable storage medium of this embodiment may be the internal storage unit of the terminal, such as the hard disk or memory in terminal: The computer-readable storage medium of this embodiment can also be an external storage device of the terminal, such as a plug-in hard disk, smart storage card, secure digital card, flash memory card, etc. equipped on the terminal; Furthermore, computer-readable storage media can also include both internal storage units of the terminal and external storage devices.

The computer-readable storage medium of this embodiment is used to store computer programs and other programs and data required by the terminal. The computer-readable storage medium can also be used to temporarily store data that has been output or will be output.

Embodiment 3: The computer device of this embodiment includes a memory; a processor, and a computer program stored on the memory and executable on the processor. When the processor executes the program, it implements the steps of the MOPSO-based reliability intelligent optimization in Compute-in-Memory chiplet-based 2.5D Packaging in Embodiment 1.

In this embodiment, the processor can be a central processing unit, as well as other general-purpose processors, digital signal processors, ASIC, ready-made programmable gate arrays or other programmable logic devices, discrete gates or transistor-based logic devices, discrete hardware components, etc. The general-purpose processor can be a microprocessor or any conventional processor; Memory can include read-only memory and random access memory, and providing instructions and data to the processor. A portion of memory can also include non-volatile random access memory, for example, memory can also store device type information.

What is claimed is:

1. A system for reliability optimization of compute-in-memory chiplet-based 2.5D packaging, comprising: a finite element modeling unit with a parameterized structural model generator based on Taguchi orthogonal experiments, which simulates thermal stress and warpage of critical bump arrays: a multi-objective analysis engine with signal-to-noise ratio range evaluation and weighted percentage scoring prioritizers; and a swarm intelligence optimizer with a multi-objective particle swarm algorithm (MOPSO) for resolving conflicting reliability targets by iteratively adjusting bump geometry and material properties.

2. The system of claim 1, wherein the multi-objective analysis engine has: a dynamic weight assigner for stress and warpage metrics based on predefined thresholds; and a Pareto-optimal parameter configuration generator for balancing mechanical reliability with signal integrity constraints.

3. The system of claim 1, further comprising a computational framework with: a stress-warpage relationship modeler using least squares fitting; and a thermal cycle lifetime improvement predictor for predicting enhancements exceeding 30% compared to baseline designs.

4. A computer-implemented method for 2.5D packaging optimization, comprising: an orthogonal experimental matrix constructor of bump parameters, including diameter, pitch, and height variations: a thermo-mechanical response simulator using finite element analysis; a multi-objective conflict resolver via MOPSO to minimize stress and warpage simultaneously; and manufacturable specification generator with quantified coplanarity tolerances and interposer thickness ranges.

5. The method of claim 4, further comprising: an adaptive finite element mesh refiner for high-stress regions during simulation; and a real-time 3D thermal stress distribution renderer through a visualization interface.

6. A non-transitory computer-readable medium storing instructions for packaging optimization, which causes a processor to have: an automated parameter screener using orthogonal design: a simulation data converter into multi-objective decision variables: a swarm intelligence algorithm executor to optimize bump configurations; and a design-rule outputter compatible with industry-standard 2.5D packaging workflows.

7. The medium of claim 6, wherein the instructions further implement domain-specific constraints including underfill material properties and bump pitch limiters.
